(19) United States
(12) Patent Application Publication
(10) Pub. No.: US 2012/0255699 A1
(43) Pub. Date: Oct. 11, 2012

(54) EXOTHERMIC WELDING MOLD WITH FILTER

(76) Inventors: Timothy P. Sepelak, Willoughby, OH (US); Keith R. Anthony, Burton, OH (US); Michael Rabinovich, Solon, OH (US)

(21) Appl. No.: 13/252,432

(22) Filed: Oct. 4, 2011

Related U.S. Application Data
(63) Continuation-in-part of application No. 13/080,067, filed on Apr. 5, 2011.

(51) Int. Cl. B23K 20/00; B22D 23/00

(52) U.S. Cl. 164/54; 164/271

(57) ABSTRACT

An exothermal weld mold includes a mold section with an integral cover portion, made as part of a single piece of material with the rest of the mold section. The mold section may be a mold half of a vertically split mold, or may constitute most of a half of the mold. The cover portion may be part of an integral cover that covers substantially all of a reaction chamber or crucible of the mold. The cover may have one or more vent holes, in the top and/or side of the mold. The cover may have a baffled passage for expansion of gases produced by reaction of the weld material, before the gases are expelled from the mold at an opening in the top or side of the mold. The passage may be a serpentine passage. A filter may be placed in the passage.

This application is a continuation-in-part of U.S. Application No. 13/080,067, filed Apr. 5, 2011, the entire disclosure of which is incorporated herein by reference.

### TECHNICAL FIELD OF THE INVENTION

The invention is in the general field of exothermic welding.

### DESCRIPTION OF THE RELATED ART

Exothermic welding is a method that utilizes a self-propagating exothermic reaction that produces and delivers molten metal for permanently joining (welding) various metallic conductors in any of a myriad of combinations. Examples of self propagating exothermic reactions are found in the CADWELD® process and the Thermit® process. CADWELD is a trademark of ERICO International Corporation, Solon, Ohio, U.S.A., and Thermit is a trademark of Th. Goldschmidt AG, Essex, Germany. Exothermic mixtures are basically a combination of a reductant metal and usually a transition metal oxide. An example is aluminum and copper oxide, which upon ignition supplies enough heat to propagate and sustain a reaction within the mixture. It is usually the molten metal product or the heat of this reaction, which is then used to produce a desired result. The CADWELD process produces, for example, a mixture of molten copper and aluminum oxide or slag. The molten copper has a higher density than the slag and is usually directed by a mold to join or weld copper to copper, copper to steel, or steel to steel. The aluminum oxide slag is removed from the weld or joint and discarded. Another common mixture is iron oxide and aluminum. Where only the heat of the reaction is used, the heat may be used to fuse brazing material, for example.

The most common way to contain the exothermic reaction, and to produce the weld or joint, involves the use of split graphite molds (see prior art example in FIG. 1, showing a cutaway of a horizontally split mold). The conductors or items to be joined (e.g., bars) 22 and 24 are thoroughly cleaned and then placed in the appropriate location to project into a weld chamber 26 in a graphite mold 12 of a welding apparatus 10. The mold is then securely closed and locked usually with a toggle or other clamp. The molds typically include a crucible or reaction chamber 30 above the weld chamber, connected to the weld chamber by a tap hole 32. An appropriate amount of exothermic material 36 is placed in the mold crucible, either in a sealed container or poured loose onto a metal disk 34 placed in the bottom of the crucible. The mold cover 20 is then closed and the reaction initiated either through the use of a flint igniter with starting material 40 or an electrical igniter. When the exothermic material is ignited, the molten metal phase separates from the slag and melts through the metal disk or container. The molten metal then is directed via the tap hole to the weld chamber and the conductors to be joined. Once the metal has solidified, the mold body sections 14 and 16 are opened and the slag is separated from the weld connection. The mold may then be cleaned and readied for reuse for the next connection.

### SUMMARY OF THE INVENTION

An exothermic welding mold has a passage for venting gases from a reaction chamber. The gases are vented through a passage in the mold. A filter is located in the passage, such as in a filter space, in order to reduce the vented amount of smoke, fumes, and other by-products from the exhaust gases produced in the reaction. The mold may include two or more mold sections that together define the reaction chamber and the passage, with at least one of the sections being a single-piece mold section that defines parts of both the reaction chamber and the passage.

Other embodiments described herein include exothermic welding molds that incorporate an integral cover, the benefits of which are increased exothermic welding reaction containment and gas-venting control, while also improving mold quality and durability in use, simplifying mold manufacturing processes, and reducing costs to produce molds. Prior problems with exothermic welding molds include occasionally decreased reaction containment and gas-venting control, loose and/or broken mold cover hinges, broken molds at hinge attachment points, and potential to not use the cover at all.

Embodiments described herein include a new and novel configuration for the split graphite molds that incorporates a gas-venting cover integrally into the same continuous graphite parts that form the weld chamber (cavity) and crucible. The purpose is to help contain the exothermic reaction and control the venting of hot gases from the mold. Disclosed embodiments accomplish these functions more effectively than standard molds now in use.

According to an aspect of the invention, an exothermic weld mold includes: a pair of mold sections, wherein the mold sections together define at least a reaction crucible for receiving an exothermic weld metal material. At least one of the mold sections also partially defines a passage for venting gases from the reaction crucible. The passage includes a filter space for receiving a filter that filters the exhaust gases passing through the passage.

According to another aspect of the invention, an exothermic weld mold includes: a mold section having a crucible portion that defines part of a reaction crucible for receiving an exothermic weld metal material. The mold section includes an integral-formed cover portion, formed with the rest of the mold section as a single piece of material. The cover portion includes a passage therethrough to an opening for expelling gasses from a reaction crucible portion of the mold section. The cover portion has a filter space in the passage for receiving a filter.

According to a further aspect of the invention, a method of exothermic welding includes: reacting weld material in a reaction crucible of a mold to produce molten weld material; and venting gases from the reacting through a passage in the mold an opening in the mold, wherein the venting includes passing the gases through a filter in the passage.

According to one aspect of the invention, an exothermic welding reaction mold cover is integral to the mold itself (versus being a separate piece, or a separately attached piece).

According to another aspect of the invention, an integral mold cover is naturally closed along with the mold itself by the standard mold handle clamps now in use.

According to yet another aspect of the invention, an integral mold cover is machined in the same operation as the mold itself from a continuous block of graphite (or other suitable material).

According to still another aspect of the invention, an integral mold cover eliminates the gap between the mold top (crucible section) and standard mold covers now in use. This feature increases exothermic welding reaction containment and gas-venting control.

According to a further aspect of the invention, an integral mold cover allows for manufacturing of more intricate and effective baffles for controlled venting of reaction-gases. This feature also increases containment of exothermic welding reactions.

According to a still further aspect of the invention, an integral mold cover eliminates the mold cover hinge (from vertically split molds), which is prone to quality problems during use. This feature also eliminates a manual production assembly step, reducing production costs.

According to another aspect of the invention, an exothermal weld mold includes: a mold section having a crucible portion that defines part of a reaction crucible for receiving an exothermic weld metal material. The mold section includes an integral-formed cover portion, formed with the rest of the mold section as a single piece of material, that covers the reaction crucible at least in part.

According to yet another aspect of the invention, an exothermal weld mold includes: a mold section having a crucible portion that defines part of a reaction crucible for receiving an exothermic weld metal material. The mold section includes an integral-formed cover portion, formed with the rest of the mold section as a single piece of material. The cover portion includes a passage therethrough to an opening for expelling gasses from a reaction crucible portion of the mold section.

According to still another aspect of the invention, a method of exothermic welding includes: reacting weld material in a reaction crucible of a mold to produce molten weld metal; and venting gases from the reacting weld material through an opening in the mold, wherein the opening is in a cover portion of a mold section of the mold that is formed as part of a single piece with a crucible portion of the mold that at least in part defines the reaction crucible.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The accompanying drawings, which are not necessarily to scale, show various aspects of certain exemplary embodiments of the invention.

FIG. 1 is a cutaway view of a prior art welding apparatus that includes a horizontally split mold.

FIG. 2 is an oblique view of a mold section with an integrally-formed cover and a filter space, in accordance with an embodiment of the invention.

FIG. 3 is an oblique view of the mold section of FIG. 2, with a filter installed in the mold section.

FIG. 4 is an oblique view of a mold that includes the mold section of FIG. 2.

FIG. 5 is a sectional view of a prior art weld material self-contained crucible assembly.

FIG. 6 is an oblique view of a mold section with filter, in accordance with a second embodiment.

FIG. 7 is an oblique view of a mold section with a filter, in accordance with a third embodiment.

FIG. 8 is an oblique view of a mold section with a filter, in accordance with a fourth embodiment.

FIG. 9 is an oblique view of a mold, in accordance with a fifth embodiment.

FIG. 10 is an oblique view of a mold, in accordance with a fifth embodiment.

FIG. 11 is an oblique view of a mold, in accordance with a sixth embodiment.

FIG. 12 is an oblique view of a mold section of the mold of FIG. 11.

### DETAILED DESCRIPTION

An exothermal weld mold includes a mold section with an integral cover portion, made as part of a single piece of material with the rest of the mold section. The mold section may be a mold half of a vertically split mold, or may constitute most of a half of the mold. The cover portion may be part of an integral cover that covers substantially all of a reaction chamber or crucible of the mold. The cover may have a baffled passage for expansion of gases produced by reaction of the weld material, before the gases are expelled from the mold at an opening in the top or side of the mold. The passage may be a serpentine passage. A filter may be placed in the passage. The use of the integral cover portion improves mold life and performance, and reduces manufacturing effort and costs.

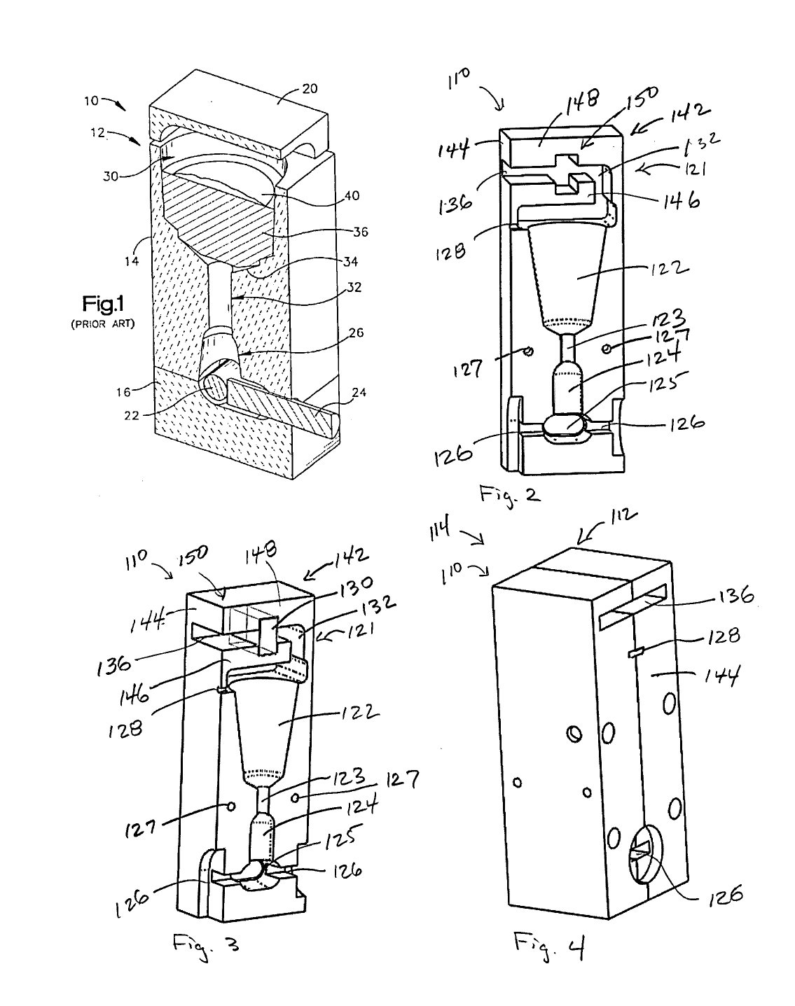

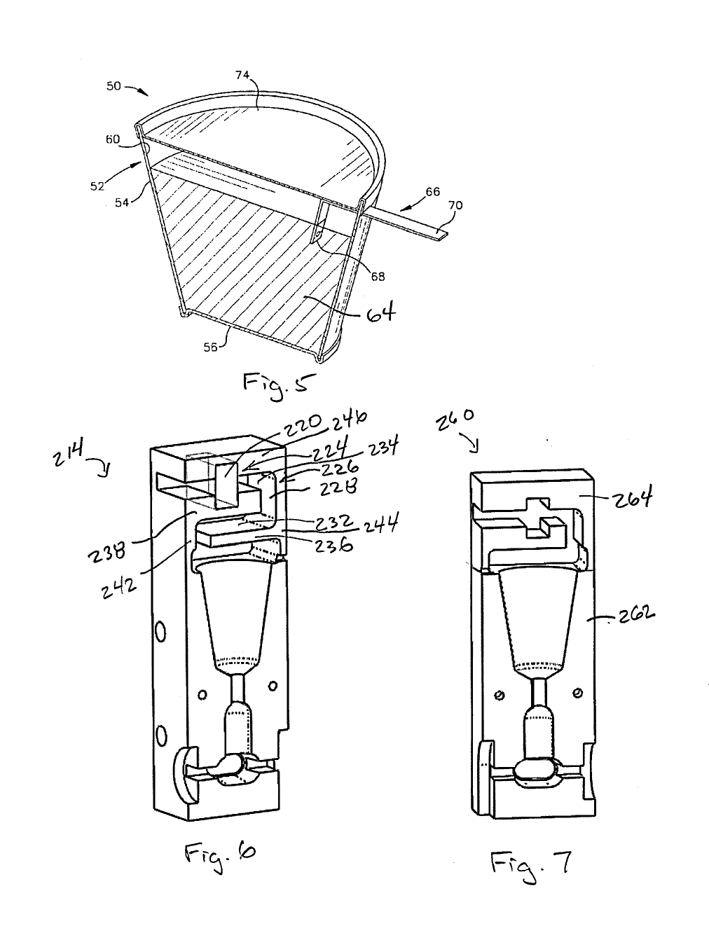

FIGS. 2 and 3 show one-half of a vertically split graphite mold (a “mold section”) 110 used for exothermic welding. The mold section 110 is used with a mating section 112 to form a mold 114, shown in FIG. 4. The graphite mold consists of three primary sections (indicated in FIG. 1 for clarity), a weld chamber or cavity 125, a reaction crucible 122 and a baffled gas-venting cover 121. All sections of the mold section may be integrally incorporated into the same mold part.

In the present example, a self-contained welding material container (e.g., CADWELD PLUS) is situated into the mold section 110 such that the igniter extends through the igniter opening 128. Further details regarding the CADWELD PLUS system may be found at www.erico.com, the website of ERICO International Corporation, of Solon, Ohio USA, the seller of the CADWELD PLUS system, and in U.S. Pat. No. 6,835,910, the figures and description of which are incorporated herein by reference. Referring to FIG. 5, the CADWELD PLUS system utilizes a self-contained crucible assembly 50 for forming a weld between a pair of metal articles. The crucible assembly 50 includes a container 52 with side walls 54 and a fusible bottom 56; an optional refractory material liner 60; an exothermic weld material 64 within the container 52; an igniter 66 with a first end 68 partially within or close to the weld material 64, and a second end 70 protruding the container 52; and a cover 74, such as a foil, sealing the weld material within the container 52. The welding material container 52 is supported in place by a suitable profile of the crucible 122. Conductors or items to be joined are thoroughly cleaned and then placed in the conductor opening(s) 126 to project into a weld chamber 125 in the graphite mold. The mold is then securely closed and locked usually with a toggle or other clamp, and the reaction initiated by the electrical igniter. When the exothermic material is ignited the self-propagating reaction proceeds quickly, hot gases vent through the integral baffle cover 121, and the liquefied molten metal phase separates from the slag and melts through the bottom of the welding material container. The molten metal then is directed via the tap hole 123 to the weld chamber 125 and the conductors to be joined, while the slag remains in the slag cavity 124. Once the metal has solidified, the mold body sections are opened and the slag is separated from the weld connection. The mold may then be cleaned and readied for reuse for the next connection.

FIGS. 2-4 show the following parts for the illustrated mold sections: an integrated baffled vent (cover) 121, a reaction crucible (crucible portion or reaction chamber) 122, a tap 123, a slag cavity 124, a weld chamber (weld cavity) 125, conductor opening(s) 126, alignment dowel holes 127 for receiving suitable dowels for alignment of mold sections, and an igniter slot 128. Molds may be formed from a pair of identical or complementary mold sections. Two mold sections may form a complete mold, with the mold sections having a vertical split between them, such as with the illustrated mold sections. Alternatively there may be three or more mold sections including both at least one vertical split and at least one horizontal split.

The mold section 110 also includes a filter 130 in a passage 132 between the reaction chamber 122 and an exit opening 136 wherein gases are expelled from the mold section 110. The passage 132 is in an integrally-formed cover part 142 of the mold section 110. The passage 132 directs gasses from the reaction chamber 122 to the exit opening 136, which is in a side surface 144 of the mold 114. The passage 132 extends across the mold 114, with a ledge or baffle 146 separating most of the passage 132 from the reaction chamber 122. The ledge 146 may be substantially parallel to a top part 148 of the cover.

Pressurized gases produced in the reaction chamber 122 enter the passage 132 at an inlet on one side of the mold 114, opposite the igniter slot 128 through which the igniter of the crucible assembly 50 (FIG. 5) passes. The pressurized gasses travel between the ledge 146 and the top part 148, and exit through the side opening 136. This type of configuration is referred to herein as a baffled cover, in that the ledge 146 and the top part 148 act as baffles, directing and/or obstructing flow of pressurized gases produced by the reaction in the reaction chamber 122 of the mold 114. Many of the embodiments described below are also baffled covers, with top surfaces and/or ledges directing and/or obstructing flow. Some of the embodiments described below employ more intricate series of baffles than those of the mold 114.

The filter 130 is placed in a filter space 150 that is configured for receiving the filter 130. The filter 130 extends into the passage 132 of the mold section 110, as well as the passage of the corresponding mold section 112 (FIG. 4) that combines with the mold section 110 to constitute the mold 114 (FIG. 4). The filter 130 may be used to reduce the amount of smoke, fumes, and other by-products in exhaust gases that are produced in the reaction chamber 134.

Suitable materials for the filter 130 include such materials as vitreous carbons, graphite materials, silicon carbide materials, zirconium oxide fabric, and ceramic coated metal fabrics. Ceramic filters should be placed at a distance from the reaction material to avoid fusion of the filter surface. In certain applications metal wool or mesh of carbon steel or other metals may be utilized. Such other metals may include stainless steel, non-ferrous alloys such as super alloys, or refractory metals such as molybdenum, tungsten, etc. Further details on suitable filter materials and configurations may be found in U.S. Pat. No. 4,889,324, the description and figures of which are incorporated herein by reference.

The combination of the filter with the integral vented cover allows the benefits of both filters and an integral cover to be realized. A separate filter assembly is not required, and the placement of the filter may be optional, allowing an end user to employ a filter only in certain situations, for example only when working in confined spaces.

The concept for molds with an integrated baffle cover offers advantages in exothermic welding reaction containment and gas-venting control, manufacturing and cost savings to produce, product quality and durability in use, and ease of use. Premium exothermic welding mold products (e.g., the CADWELD EXOLON molds sold by ERICO International Corporation of Solon, Ohio USA) do exist that may offer increased reaction containment and gas-venting control over current standard molds, but such premium products require additional parts, are more costly, and are more complex to use. The mold sections described above achieve similar if not equivalent reaction containment and gas-venting control to premium products, but accomplish this in what would be considered “standard” mold product.

Molds with integral covers for performing exothermic welding increase reaction containment and gas-venting control by allowing for incorporation of more intricate and effective baffles and by eliminating the gap that exists between the mold top (crucible section) and separate mold cover typically in use. This described gap presents an undesired path for both hot gases and molten metal to escape during exothermic reactions, instead of venting strictly through the cover as intended. Present cover baffles are limited by reasonable manufacturing capabilities and/or cost to produce. Another problem with a separate mold cover is the potential for a user to not close the cover at all, providing almost no reaction containment. However, integral mold covers are locked closed along with the mating mold parts themselves by the standard mold handle-clamps in use. This ensures a tight seal between the mold cover halves is maintained. Further, molds incorporating the integral cover allow previously unreachable machining access to create better cover baffling schemes.

The integral mold cover described above eliminates the mold cover hinge (from vertically split molds), which is prone to quality problems during use and assembly. The hinges used with present mold covers can decrease the life of graphite molds by breaking molds at screw attachment points, and further the hinges can also cause increasing gaps between mold crucibles and covers as described in the paragraph above as the hinges deteriorate in function upon experiencing the thermal cycles of exothermic welding. Also by eliminating the hinge, the integrated mold cover also eliminates a manual production assembly step, reducing production costs.

Additionally, the integral mold cover is machined in the same operation as the mold itself from a continuous block of graphite (or other suitable material). This actually simplifies and reduces total mold machining requirements, reducing production cost.

The integral mold cover described above can be applied to both vertically split and horizontally split molds. Vertically split molds maximize the benefits described above, whereas horizontally split molds may incorporate a fully integrated baffle cover on one mold half while the other mold half uses a hinge for the crucible/cover section and/or lock closed via toggle clamps or press-fit latches as used in various known molds. Horizontally split molds may be converted to vertically split molds, where practical, to maximize the benefits of the integral baffle cover. Other methods for integrating this cover into horizontally split molds may be utilized.

The integral mold cover concept can be applied to all molds utilized for exothermic welding regardless of the thousands of configurations of weld cavities employed for any combinations of conductors to be welded, not just those depicted pictorially or schematically herein. Similarly, the baffle in the cover section of the mold can take on many variations, not just those depicted pictorially or schematically herein.

The combination of a filter and an integral cover provides the advantages of both. The filter may be in any of a variety of suitable shapes. The filter space 150 may be a portion of the passage 132 having a cross-sectional area greater than that of the rest of the passage 132. The filter space 150 may have a vertical extent that is greater than a vertical extent of other parts of the passage 132. Alternatively or in addition, the filter space 150 may have a horizontal extent that is greater than a horizontal extent of other parts of the passage 132. The passage 132 and/or the filter space 150 may have a rectangular cross-section shape, or other suitable shapes.

Filters may be combinable with any of the other suitable embodiments disclosed herein, for example in any of the baffled embodiments described herein. FIG. 5 shows one such alternative, a mold section 214 having a filter 220 in a filter space 224 in a serpentine passage 226. The term “serpentine passage” is used herein to refer to a passage that changes direction with turns of 90 degrees or more. Passages having shallower turns are also possible. The serpentine passage 226 has an intermediate turn 228 of about 180 degrees, with gases entering the turn 228 from a lower passage portion 232 being turned to substantially the opposite direction to travel through an upper passage portion 234.

The lower passage portion 232 is bounded by a pair of ledges 236 and 238 that are connected to respective opposite side walls 242 and 244, as well as to the back wall, of the mold section 214. The upper passage portion 234 is bounded by the ledge 238 and a top part 246 of the cover portion of the mold section 214.

The mold section 214 is combined with a corresponding shape mold section (not shown) to form a complete mold, that can be held together with suitable clamps, for example. The same is true for other embodiments shown herein as only a single mold section, that a corresponding mold section may be combined with the illustrated mold section to produce the complete mold.

As another alternative, a filter may be placed in a baffled passage or other flow-turning passage of a separate module that is coupled to a mold. Separate baffle modules are described in U.S. Pat. No. 4,881,677, and separate filter modules are described in U.S. Pat. No. 4,889,324. Such a separate module, with both baffles (or flow turning without baffles) and a filter, could be coupled to a mold using suitable threaded fasteners or clamps, for example.

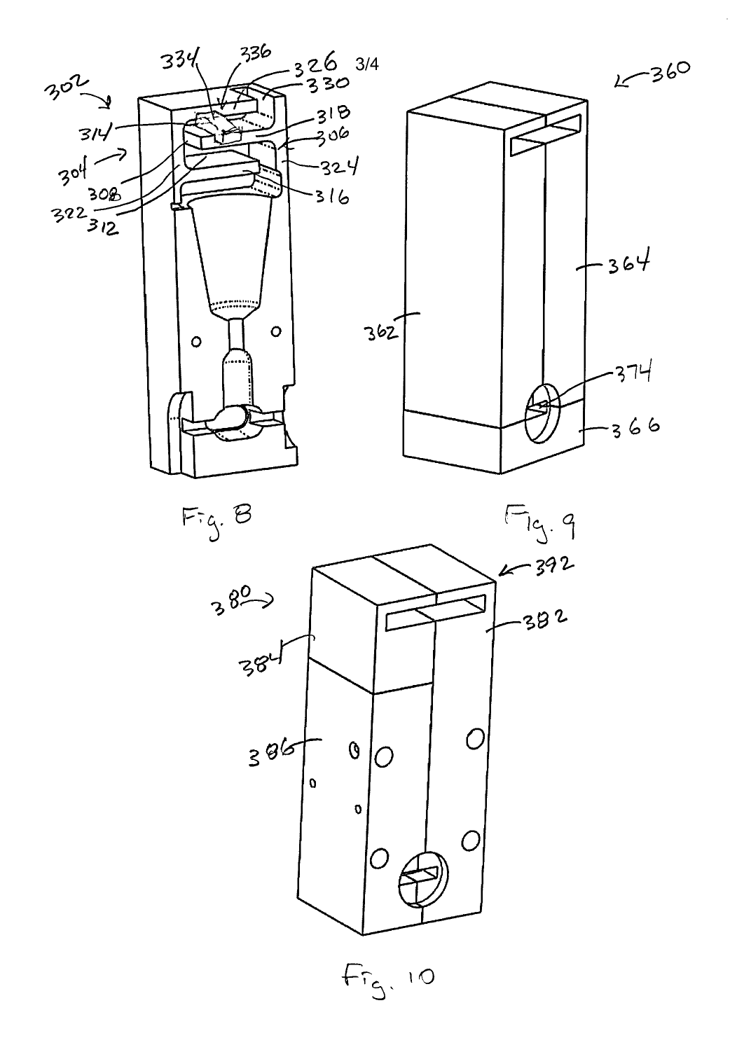

FIG. 7 shows a mold section 260 in which a crucible portion module 262 is separate from a cover portion module 264. In other respects the mold section 260 is similar to the mold section 214 (FIG. 6). The mold section 260 may be combined with either a single-piece corresponding mold section (not shown) or a horizontally-split corresponding mold section (not shown). The crucible portion module 262 and the cover portion module 264 may be held together with suitable clamps. Alternatively, the crucible portion module 262 and the cover portion module 264 may be machined separately, and then permanently joined together.

While the mold improvements described herein may be used with ERICO's CADWELD PLUS product line, the integrated mold cover may also be used with ERICO's traditional CADWELD product line as well. The CADWELD product line utilizes loose exothermic mixtures, powders that are a combination of a reductant metal and usually a transition metal oxide, as described above with regard to FIG. 1. Use of powdered weld-metal-producing material requires slightly different profiles for both the crucible (reaction chamber) and the baffle cover sections of the mold than depicted in FIGS. 2-4.

Though graphite molds are typically used for exothermic welding, other mold materials could be used as well. Besides graphite, a wide variety of ceramic materials could be used for the molds. Another alternative is metal, such as coated steel.

As an alternative to the mold sections with the cover portion being integrally formed as a single piece of material, the cover portions and the rest of the mold sections may be separate pieces that are permanently joined together. Such permanent joining or attaching may be accomplished by suitable methods.

FIG. 8 shows a single-piece mold section 302 that has an integral cover portion 304 that has a serpentine passage 306. The serpentine passage 306 has an intermediate turn 308 of about 180 degrees, with gases entering the turn 308 from a lower passage portion 312 being turned to substantially the opposite direction to travel through an upper passage portion 314.

The lower passage portion 312 is bounded by a pair of ledges 316 and 318 that are connected to respective opposite side walls 322 and 324, as well as to the back wall, of the mold section 302. The upper passage portion 314 is bounded by the ledge 318 and a top part 326 of the cover portion 304. The passage 306 has an outlet 330 through a top surface of the mold section 302.

A filter 334 fits in a filter space 336 within the passage 306. In the illustrated embodiment the filter space 336 is shown as being in the upper passage portion 314, but alternatively the filter space 336 may be located in other parts of the passage 306.

FIG. 9 show a three-piece mold 360, having a pair of vertically-split upper mold sections 362 and 364, horizontally split from a bottom mold section 366. The horizontal split comes at a weld chamber and a conductor opening 374 of the mold 360. The bottom mold section 366 defines the bottom of the weld chamber and the conductor openings, and the upper mold sections 362 and 364 define the top of the weld chamber and the conductor openings. In other characteristics the mold 360 may be similar in configuration to the mold section 214 (FIG. 6) and its complimentary mold section. The horizontal split shown in FIG. 8 may be used as an alternative with the other embodiments described herein.

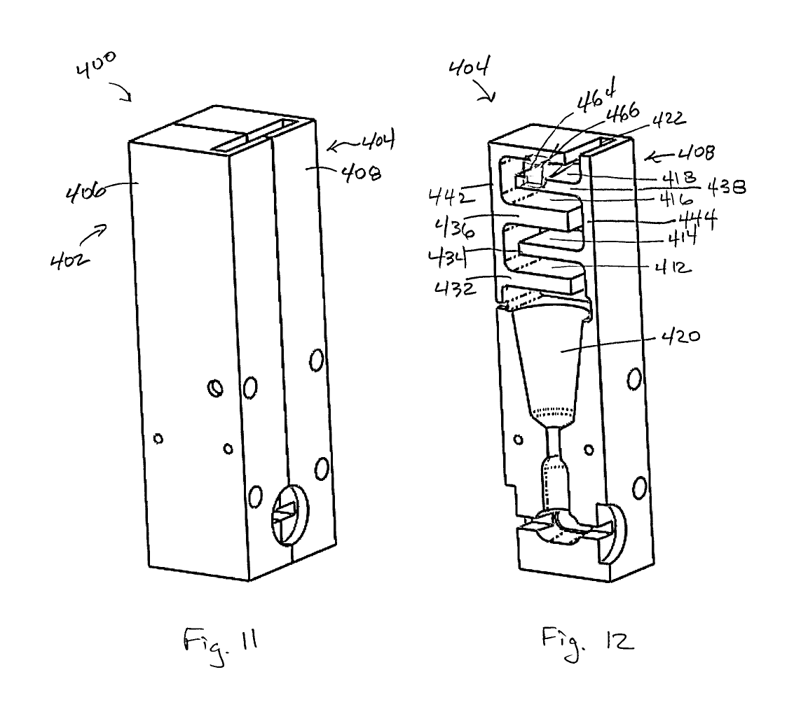

FIG. 10 show a different three-piece mold 380, one having a mold section 382 that forms half of the mold 380. The mold section 382 is vertically split from a pair of mold sections 384 and 386. The mold sections 384 and 386 are stacked one on top of the other to together form a complimentary shape to the mold section 382. The horizontal split between the mold sections 384 and 386 is located at the top of the reaction crucible. The upper mold section 384 has ledges and a serpentine passage shape that compliments the configuration of a cover portion 392 that is part of the mold section 382. The upper mold section 384 and the cover portion 392 together constitute a baffled cover that is similar in shape to that of the mold section 214 (FIG. 5) and its complimentary mold section. The upper mold section 384 may be connected to the lower mold section 386 by a hinge (not shown), or may be held in place by other means, such as a clamp. Except for the horizontal split between the mold sections 384 and 386, the mold 380 may have characteristics that are the same as a mold produced from the mold section 214 (FIG. 6) and its complimentary mold section.

FIGS. 11 and 12 show a mold 400 that is made up of a pair of vertically-split mold sections 402 and 404. The mold sections 402 and 404 have respective cover portions 406 and 408 with more intricate baffled serpentine passages than other embodiments described above. The mold section 404 has a passage 410 that has four passage portions 412, 414, 416, and 418, between a reaction chamber 420 and an opening 422 for venting gases from the mold 400. The volume between the reaction chamber 420 and the opening 422 is broken up by a series of ledges 432, 434, 436, and 438. The ledges 432 and 436 emerge from a first side wall 442, and the ledges 434 and 438 emerge from a second side wall 444, which is opposite the first side wall 442. The ledges 432-438 are also in direct contact with a back wall 446 of the mold section 404. The ledges 432-438 thus interdigitate, and they act as baffles, along with a top part 448, that define the portions 412-418 of the passage 410. A filter 464 fits in a filter space 466 within the passage 410. In the illustrated embodiment the filter space 466 is shown as being in the uppermost passage portion 418, but alternatively the filter space 466 may be located in other parts of the passage 410.

The baffles (ledges) in the various embodiments described herein aid in allowing the pressurized gas passing through it to expand and be reduced in velocity. The portions of the passages function as a series of expansion chambers to facilitate this process. The expansion, direction change, and large surface area of the integral baffle covers described herein allows the gases to slow and cool before being exhausted through the opening(s) of the cover. The exhaust of molten metal splatter and flames may be eliminated, and the amount of smoke exhausted may be greatly reduced, since particulate matter is accumulated on the inner surfaces of the baffled cover.

The desirable amount of baffling depends upon the size of the reaction (the amount of exothermic weld material used), as well as other possible factors. For small reactions, it may be sufficient to have a cover with one or more vent holes without baffling, or even no cover venting at all. For larger reactions the volume of gases generated is greater, and some baffling is desirable, with more intricate baffling (a longer gas passage, with more expansion chambers) being more desirable the larger the reaction is.

The embodiments described above are shown with filters in place. However placement of the filter may be optional, and the filter may be omitted if desired by the user.

As noted above, molds with integral baffled covers may be utilized with loose particulate weld-metal-producing exothermic weld material, ignited with starting powder. Such ignition may be accomplished by placing a small amount of starting material on each of the horizontal plates or ledges. The ignition of the starting material on the uppermost plate or ledge will cause a chain reaction igniting the starting material on each successively lower plate or ledge. This proceeds until the reaction reaches the starting material placed on the loose weld material in the reaction chamber. Ignition of this starting material initiates the reaction in the main weld material, and the reaction proceeds normally, as described above. Use of starting material on baffles to initiate a reaction is described further in U.S. Pat. No. 4,881,677, the description and figures of which are incorporated herein by reference.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1-2. (canceled)

3. An exothermic weld mold comprising:
a pair of mold sections, wherein the mold sections together define at least a reaction crucible for receiving an exothermic weld metal material;
wherein at least one of the mold sections also partially defines a passage for venting gases from the reaction crucible;
wherein the passage includes a filter space for receiving a filter that filters the exhaust gases passing through the passage;
wherein the passage is in a cover that substantially fully covers the reaction crucible; and
wherein the cover and the mold sections are made of the same material, with the material of the cover substantially fully covering the reaction crucible.

4. An exothermic weld mold comprising:
a pair of mold sections, wherein the mold sections together define at least a reaction crucible for receiving an exothermic weld metal material;
wherein at least one of the mold sections also partially defines a passage for venting gases from the reaction crucible;
wherein the passage includes a filter space for receiving a filter that filters the exhaust gases passing through the passage;
wherein the passage is in a cover that covers the reaction crucible at least in part; and
wherein the mold sections include respective integral-formed cover portions, wherein each of the mold sections is formed as a respective single piece of material.

5. The exothermic weld mold of claim 4, further comprising a filter in the filter space.

6. The exothermic weld mold of claim 5, wherein the filter includes one or more of vitreous carbon, graphite material, silicon carbide material, zirconium oxide fabric, and ceramic coated metal fabric.

7. The exothermic weld mold of claim 4, wherein the passage includes at least one change of direction between the reaction chamber and the opening.

8. The exothermic weld mold of claim 4, wherein the passage is a serpentine passage that changes direction at least twice between the reaction chamber and an opening of the passage from which exhaust gases are expelled.

9. The exothermic weld mold of claim 4, wherein one or both of the mold sections are horizontally split.

10. The exothermic weld mold of claim 4, wherein the filter space has an increased cross-section area relative to the rest of the passage.

11. The exothermic weld mold of claim 10, wherein the cross-section area of the filter space is of greater extent both vertically and horizontally, relative to the rest of the passage.

12. An exothermic weld mold comprising:
a mold section having a crucible portion that defines part of a reaction crucible for receiving an exothermic weld metal material;
wherein the mold section includes an integral-formed cover portion, formed with the rest of the mold section as a single piece of material;
wherein the cover portion includes a passage therethrough to an opening for expelling gasses from a reaction crucible portion of the mold section; and
wherein the cover portion has a filter space in the passage for receiving a filter.

13. The exothermic weld mold of claim 12, wherein the passage is a serpentine passage that changes direction at least twice.

14. The exothermic weld mold of claim 12, wherein the filter space has an increased cross-section area relative to the rest of the passage.

15. The exothermic weld mold of claim 12, further comprising a filter in the filter space.

16. The exothermic weld mold of claim 15, wherein the filter includes one or more of vitreous carbon, graphite material, silicon carbide material, zirconium oxide fabric, and ceramic coated metal fabric.

17-20. (canceled)

21. The exothermic weld mold of claim 12, wherein the cover portion covers at least part of the part of the reaction crucible that is defined by the crucible portion.

22. The exothermic weld mold of claim 3, further comprising a filter in the filter space.

23. The exothermic weld mold of claim 3, wherein the passage includes at least one change of direction between the reaction chamber and the opening.

24. The exothermic weld mold of claim 3, wherein the passage is a serpentine passage that changes direction at least twice between the reaction chamber and an opening of the passage from which exhaust gases are expelled.

25. The exothermic weld mold of claim 3, wherein the cross-section area of the filter space is of greater extent both vertically and horizontally, relative to the rest of the passage.

26. The exothermic weld mold of claim 4, wherein the cover extends substantially fully over the reaction crucible.
